(19) United States
(12) Patent Application Publication
(10) Pub. No.: US 2026/0050490 A1
(43) Pub. Date: Feb. 19, 2026

(54) METHOD AND SYSTEM FOR PREVENTING RESOURCE STARVATION AND SERVICE THROTTLING IN A KUBERNETES-BASED SYSTEM

(71) Applicant: Cisco Technology, Inc., San Jose, CA (US)

(72) Inventors: Harsha Narayana, Udupi (IN); Rajiv Ginotra, Bangalore (IN); Ganesan Vivekanandan, Sunnyvale, CA (US); Ramesh Nethi, Bangalore (IN)

(21) Appl. No.: 18/807,666

(22) Filed: Aug. 16, 2024

(51) Int. Cl. G06F 9/50

(52) U.S. Cl. CPC G06F 9/5083

(57) ABSTRACT

Techniques and mechanisms for preventing resource starvation and service throttling during container orchestration system operations are provided. In a Kubernetes-based container orchestration system, pluggable mechanisms are applied to pod and/or associated container creation and operation at the direction of a cluster controller to prevent resource overloading and service throttling during thundering herd problems encountered by components of a Kubernetes cluster. A special-purpose plugin may be provided that causes creation of a pod and/or associated container according to a prescribed order to prevent caching overload and resulting thundering herd problems during pod and/or associated container creation and startup.

### TECHNICAL FIELD

The present disclosure relates generally to resource management in a computer-based network. More specifically, the techniques and mechanisms relate to managing resources and services in a Kubernetes-based system to prevent resource starvation and services throttling in a resource-limited environment.

### BACKGROUND

In modern computing systems utilized via on-premises or cloud-based networks, it has become popular to containerize software applications. Containerization of software applications includes running executable packages of software components in a container. A given container may include all components of a given application, for example, application executables, libraries, as well as dependency information relating to software application components in a given container or dependency information relating to software application components in one container with software application components in another container. A given container may include all components of a given software application, or a given container may include portions of a given software application that communicates with other portions of the software application housed in other containers. In a system of such containerized applications, for example, a Kubernetes-based container orchestration system, horizontal scaling allows additional containers of the same or related applications to be added to increase network capacity. Vertical scaling includes adding more operating resources (e.g., more central processing unit (CPU) capacity and/or memory). A network may horizontally scale by adding additional instances of a given software application by adding additional containers (each having an instance of a given software application). By adding additional containers, workloads may be distributed across multiple containers where one or more applications do not have capacity to handle the workloads. In a typical setting, such containers may be orchestrated in pods of containers where a given pod may include a single container or a number of containers that operate in concert to provide a desired functionality. A collection of such pods (one or more) may be organized in a node where a given node is responsible for providing a desired functionality provided by the combined functionalities of the individualized container of the individual containerized applications.

In on-premises and cloud-based network systems, one or more controllers may be utilized for directing the utilization of such containerized software applications, including creating, updating, starting, stopping, and deleting of application containers and/or pods of containers. Because on-premises and even cloud-based network systems may be constrained by limited computing resources, horizontal and vertical scaling is likewise limited. As a result, processing workloads assigned to containers, particularly when services running via controllers are started, stopped, updated, or re-loaded en masse, can result in caching overloads or so-called “thundering herd” problems where the computing capacity of the containerized applications and computing operating resources such as CPU and memory cannot efficiently handle all requests. Network controllers that leverage container orchestration infrastructure, such as Kubernetes, encounter thundering herd issues predominantly during operational changes, including power cycling, software upgrades, and rolling service reloads.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system architecture diagram of an environment for container orchestration.

FIG. 2 illustrates a system architecture diagram of an environment for pod and/or container creation via invocation of one or more plugins.

FIG. 3 illustrates a flow diagram of an example method for managing resource capacity and service throttling to prevent system caching overloading resulting in thundering herd problems.

FIG. 4 illustrates a flow diagram of an example method for managing resource capacity and service throttling to prevent system caching overloading resulting in thundering herd problems.

FIG. 5 illustrates a flow diagram of an example method for managing resource capacity and service throttling to prevent system caching overloading resulting in thundering herd problems.

FIG. 6 is a computer architecture diagram showing an illustrative computer hardware architecture for implementing a computing system/device that can be utilized to implement aspects of the various technologies presented herein.

### DESCRIPTION OF EXAMPLE EMBODIMENTS

### Overview

The present disclosure relates generally to resource management in a computer-based network. More specifically, the techniques and mechanisms relate to managing resources and services in a Kubernetes-based system to prevent resource starvation and services throttling in a resource-limited environment.

A method to perform techniques described herein may include receiving a request to create a pod in a container orchestration system having a control node and one or more worker nodes, and receiving a plugin configured for managing creation of the pod according to a pod creation order. Further, the techniques include determining from the received plugin that the pod is to be created in a throttled mode and creating the pod in the throttled mode according to the according to the pod creation order. Additionally, the techniques include creating the pod during a time constrained duration, and if creating the pod according to the pod creation order fails to complete during the time constrained duration, ceasing creating the pod.

A further method to perform the techniques described herein may include receiving a request to create a pod in a Kubernetes-based container orchestration system, passing the request to a Kubernetes network node agent from a Kubernetes controller via an application programming interface. At the Kubernetes network node agent, the techniques include querying a configuration file for a plugin configured for managing creation of the pod according to a pod creation order. According to the techniques, if the pod is requested for a control plane of the Kubernetes-based container orchestration system, creating and starting operation of the pod. If the pod is requested for platform components, creating the pod after the control plane is running and continuing operation the pod. Additionally, if the pod is for operating an application, creating the pod container with all components of the application after the control plane and the platform components are operating.

Additionally, the techniques described herein may be performed by a system having non-transitory computer-readable media storing computer-executable instructions that, when executed by one or more processors, performs the methods described above.

### Example Embodiments

As briefly discussed above, orchestration of containerized applications is utilized in both on-premises and cloud-based computing systems. Containerized applications allow applications to run in isolation from other applications by placing or encapsulating a given application along with its executable program programming code, dependencies, libraries, configuration files and the like. That is, a containerized application includes in a container all components and/or information associated with an application necessary to run the application. Importantly, containerized applications are portable meaning they can be operated consistently across different host systems.

When systems require horizontal scaling, containerized applications can be replicated where new containers having the same application can be created to allow application workloads to be distributed across different containers to provide additional application capacity. Additional containers having different applications needed for horizontal scaling likewise may be created. Vertical scaling, on the other hand, includes increasing operating resources, for example, additional CPU and memory. In a typical setting, containers may be orchestrated in pods of containers where a given pod may include a single container or a number of containers that operate in concert to provide a desired functionality. A collection of such pods (one or more) may be organized in a node where a given node is responsible for providing a desired functionality provided by the combined functionalities of the individual containerized applications.

In on-premises environments, the ability to scale horizontally and vertically is limited by the computing system capacity to store and operate additional application containers. Cloud-based deployments can somewhat mitigate these issues via dynamic horizontal and vertical scaling, but even cloud-based environments can reach limits on the ability to add additional containers or processing resources depending on cloud-based resources levels and/or service level agreements between users and cloud-based hosts.

In a typical environment, containerized applications are orchestrated, managed, and operated via a container orchestration system. Examples of container orchestration systems include Kubernetes, variants of Kubernetes, container as a service (CaaS), platform as a service (PaaS), and the like. Such systems, for example, Kubernetes, are responsible for creating, deploying, starting, stopping, updating, and deleting containerized applications to manage workloads across containers. Creation and deployment of containers allows a container orchestration system like Kubernetes to scale applications up or down to meet user workload demands.

In a typical container orchestration system like Kubernetes, a number of components form a container orchestration cluster, including a control plane or node and one or more worker nodes in which pods and included containers are situated and managed. The control plane or node may be provided. The control plane or node may include components responsible for managing the containers in respective pods and nodes. The control plane or node typically includes an application programming interface (API) server responsible for external communications into the cluster and for internal communications to, from, and among worker nodes, pods and containers. The control plane or node may also include a scheduler for assessing worker nodes for placement of pods to include containers based on a number of system resources and attributes. The control plane may also include a controller manager and one or more controllers that are responsible for assessing differences between a current state of cluster components, including containerized application functionality, and a desired state of cluster components. Based on such assessment, controllers communicate with the API server to create, update, start, stop and delete resources such as pods and included containers. At the worker nodes, agent applications (e.g., Kubelets) are provided which serve as node agents between controllers and nodes (including pods and included containers). In addition, Kube-proxies are included in worker nodes and provide for communications between services and pods including containerized applications operated in pods.

In deployments of on-premises Kubernetes clusters with constrained resources, the inability to scale vertically necessitates services operated via cluster controllers to be configured in a manner that ensures the most efficient use of available resources. Such optimization is important in preventing the thundering herd problem, which occurs when services provided via one or more containerized applications at the direction of cluster controllers are started, stopped, updated or reloaded en masse. Such occurrences can adversely affect the cluster in a multitude of ways, from deteriorating system performance to compromising security. In critical environments, controllers and associated nodes, pods and containerized applications facing the thundering herd problem can inflict varying degrees of impact on end users. These impacts can range from disrupting daily operations to causing data outages and potential data loss.

Controllers that leverage container orchestration infrastructure, such as Kubernetes, encounter thundering herd issues predominantly during operational changes, including power cycling, software upgrades, and rolling service reloads. The consequences of the thundering herd problem typically manifest in a number of ways, including service outage causing data loss and suboptimal utilization of cluster resources, like CPU and memory, which can initiate a series of events that progressively degrade performance of controllers and associated nodes, pods and applications. In addition, the thundering herd problem may increase peak cluster resource usage which can dramatically affect the performance of the cluster.

Thundering herd problems can be seen in different stages of the lifecycle of a controller and associated nodes, pods and applications with many of the problems occurring around power cycles, upgrades and service rolling restarts for controllers and associated nodes, pods and applications. When workflows such as controller power cycle are performed, many services come to a starting stage at the same time. When such a condition is observed in a cluster that cannot scale vertically, certain services may get throttled heavily since the overall utilization will overshoot the available resource in terms of CPU or memory across the cluster controllers. This also may lead to suboptimal services startup behavior such as observing delays in a service to be fully ready to start responding to requests, services crashing and restarting, etc. When a service that has been running for a considerable amount of time crashes and restarts, the useful work performed by the service before it crashed, and the amount of resources utilized by the service before the crash may be wasted.

This disclosure describes techniques and mechanisms for preventing resource starvation and service throttling during container orchestration system operations. More particularly, in a Kubernetes-based container operation and management system, the techniques and mechanisms described herein utilize pluggable mechanisms applied to pod and/or associated container creation and operation at the direction of a cluster controller to prevent resource overloading and service throttling during thundering herd problems encountered by components of a Kubernetes cluster.

According to examples, and as will be described in further detail below, techniques and mechanisms of the present disclosure provide for use of a plugin mechanism that may be invoked ahead of and during pod and application container creation that causes control of pod and/or associated container creation in a manner that avoids overloading cluster resources that results in a thundering herd event that causes cluster problems described above. The pluggable mechanism described herein may be utilized in and adapted to a number of controller-directed containerized application deployments. For purposes of illustration, the techniques and mechanisms described herein are described in terms of a Kubernetes-based cluster, but as should be appreciated, the pluggable mechanism of the present disclosure is equally applicable to any containerized application environment in which creating, deploying, starting, stopping, updating, and deleting of a number of components of a given containerized application cluster may overload computing system resources and result in a caching overload or thundering herd events. As will be described below, the pluggable mechanism of the present disclosure controls pod and/or associated container creation and startup sequence in an orderly fashion bound by conditions and timeouts in a more resource efficient and predictable manner while providing visibility into the reason for delays and the components being delayed in the startup cycle.

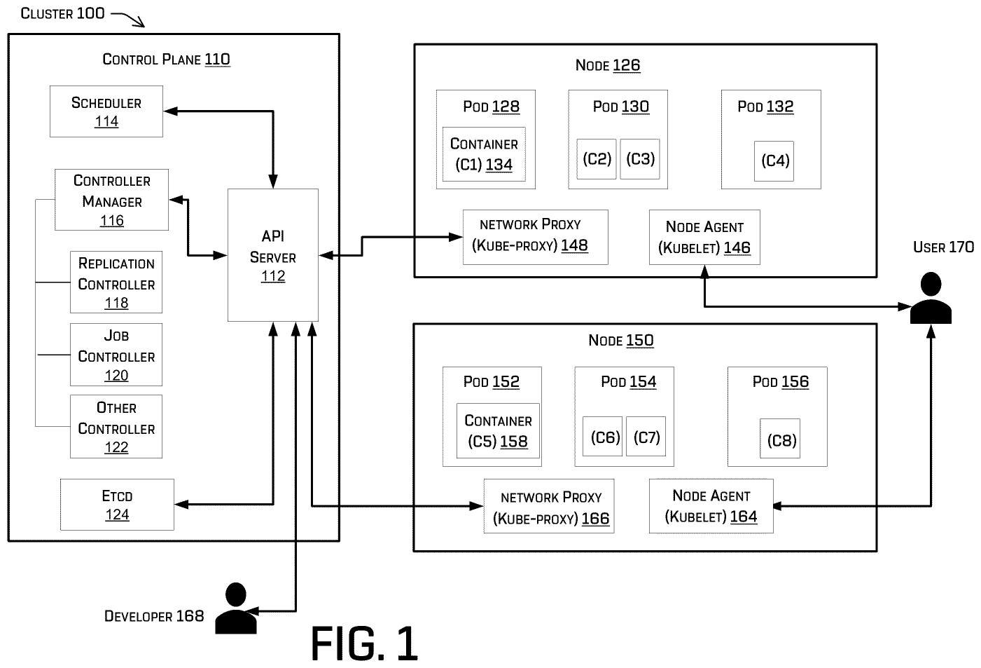

FIG. 1 illustrates a system architecture diagram of an environment for container orchestration. As briefly described above, for purposes of illustration, the techniques and mechanisms described herein are discussed in terms of a code Kubernetes-based cluster, as illustrated in FIG. 1, but as should be appreciated, the techniques and mechanisms described according to examples of the present disclosure are equally applicable to any containerized application environment in which creating, starting, stopping, updating, and/or reloading of a number of components of a given containerized application cluster may overload cluster and computing system resources and my result in caching overloads or thundering herd events. Referring then to FIG. 1, the example Kubernetes-based cluster (hereafter “cluster”) 100 includes a control plane or node 110 in which a number of control plane components are illustrated for controlling operations of the cluster 100. The cluster 100 includes one or computing nodes or worker machines that run containerized applications, as described herein.

The control plane or node 110 includes an application programming interface (API) server 112 that provides both external and internal communication interfaces for the that provides both external and internal communications to the cluster 100. For example, the API server 112 provides for communications external of the cluster 100 from developers 168 of containerized applications and other components of the cluster 100. The API server 112 may process requests, validate requests, and instruct and receive requests from cluster controllers (described below) to update the state of one or more cluster components, for example, for creation, deployment, startup, stopping, updating or deleting nodes, pods and containers, as described below.

The scheduler 114 is operative to assess cluster nodes (described below) to select where one or more pods may be placed based on CPU and memory availability, policies, and data storage locations of one or more processing workloads. The controller manager 116 may include a single controller management process that manages operations of one or more individual controllers within the cluster 100. Individual controllers may operate as separate processes, but according to examples, individual controllers may be run as a single process within the controller manager 116 to reduce cluster 100 complexity.

Referring still to the control plane or node 110, a number of controllers may be operated via the controller manager 116. For example, a replication controller 118 may request replication of one or more pods and associated containers for horizontal scaling. A job controller 120 may run one or more pods and associated containers to perform a task as requested via the API server 112 via developers 168 or from a user 170. The job controller 120 may ensure that the cluster 100 includes appropriate numbers of nodes 126, 150 and associated Kubelets 146, 164 (described below) required for completing a requested task or operation. According to examples, the job controller 120 does not actually run the pods included in the nodes 126, 150, but instead communicates through the API server 112 to create or remove pods and associated containers required for performing the requested task or operation. That is, as understood by those skilled in the art, the job controller 120 is responsible for causing a current state of the cluster to approach a desired state of the cluster 100 where the desired state is associated with completion of the requested task or operation. Other controllers 122 may include a daemon set controller that ensures that each node 126, 150 receive one copy of a designated pod for scaling purposes. Other controllers 122 may also include customized controllers built and deployed in the control plane or node 110 for carrying out customized operations through the API server 112, as described herein.

In addition to the controllers 118, 120, 122 operating via the controller manager 116, control of cluster 100 operations may be performed by direct control. For example, a given controller, for example a customized controller may need to make changes or direct operations of applications or other components outside the cluster 100. For example, a controller 122 may communicate through the API server 112 to a computing system component, for example a server or application external to the cluster 100.

The Etcd 124 may store overall configuration data for the cluster 100 (for example, state and details of one or more pods (described below) including representing a state of the cluster 100. According to examples, the API server 112 may use Etcd 124 data to monitor the cluster 100 to make changes to the cluster to allow the cluster 100 to approach a desired system state.

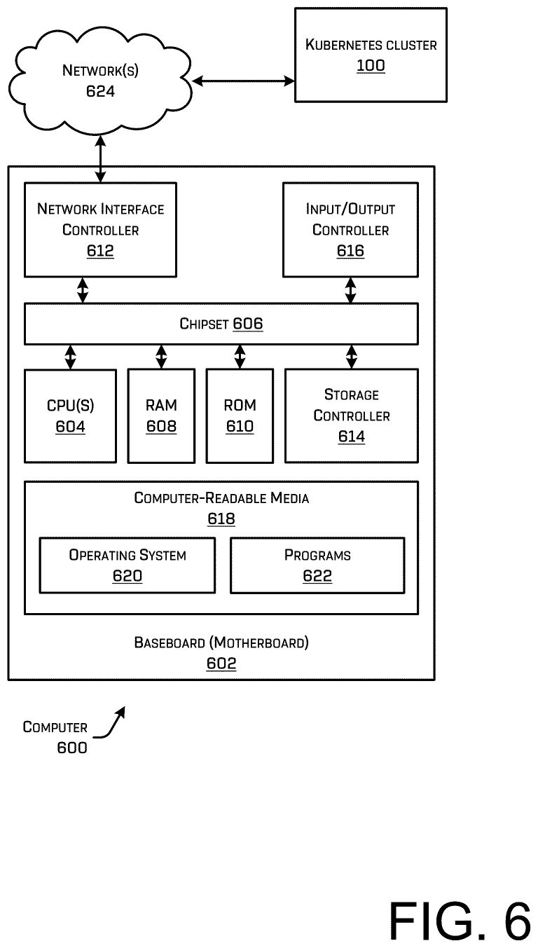

Referring still to FIG. 1, the nodes 126, 150 are illustrative of physical or virtual servers or computing systems, for example, as described below with reference to FIG. 6, on which pods and associated containerized applications may operate. According to examples, each of the nodes 126, 150 may include one or more pods 128, 130, 132 (node 126) and/or pods 152, 154, 156 (node 150). As understood by those skilled in the art, pods serve as primary building blocks of the cluster 100 and house one or more containers in which are maintained containerized applications. Pods may be automatically replaced or created to add additional CPU and memory resources for purposes of vertical scaling, or pods may be replicated to add additional containerized applications for purposes of horizontal scaling. Pods may be assigned IP addresses with which pods may be addressed by the API server 112. A set of pods operating together in a given node 126, 150 may form a scalable workload that is managed by a given controller, for example, a job controller 120.

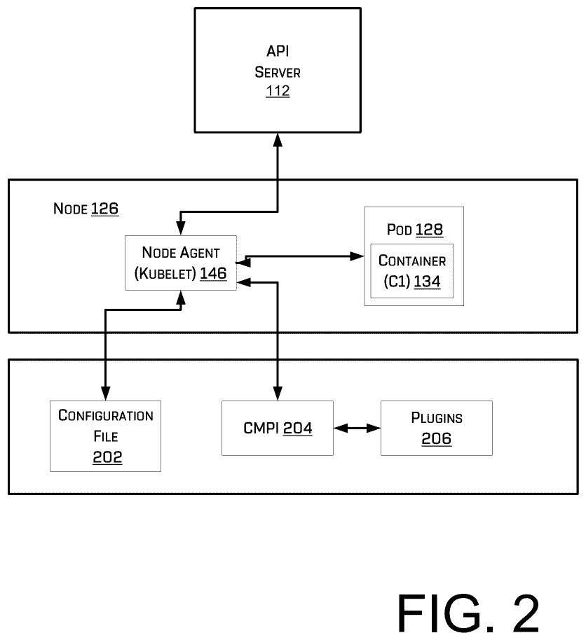

As described herein, each of the pods contained in a node 126, 150 may include one or more containers. As illustrated in FIG. 2, pod 128 includes container 134 (C1), pod 130 includes two containers C2 and C3. Pod 132 includes one container, C4. Pod 152 includes one container 158 (C5). Pod 154 includes two containers, C6 and C7, and pod 156 includes one container, C8. As should be appreciated the illustrated pods and containers are for purposes of illustration only and is not limiting of a vast number of pods and container configurations that may be utilized according to examples of the present disclosure.

According to examples, a given pod may include a single container in a one container configuration, or a pod may include a number of containers each of which may include a containerized application. Containers may include self-enclosed software instances with all required software programming, libraries and dependencies necessary to run an isolated “micro-application.” According to examples, each container may include software and its dependencies that may be rapidly copied and multiplied to scale up or down based on changing workload demands. For example, to scale an application, more instances of a container can be added instantaneously where each added container may include an instance of the application.

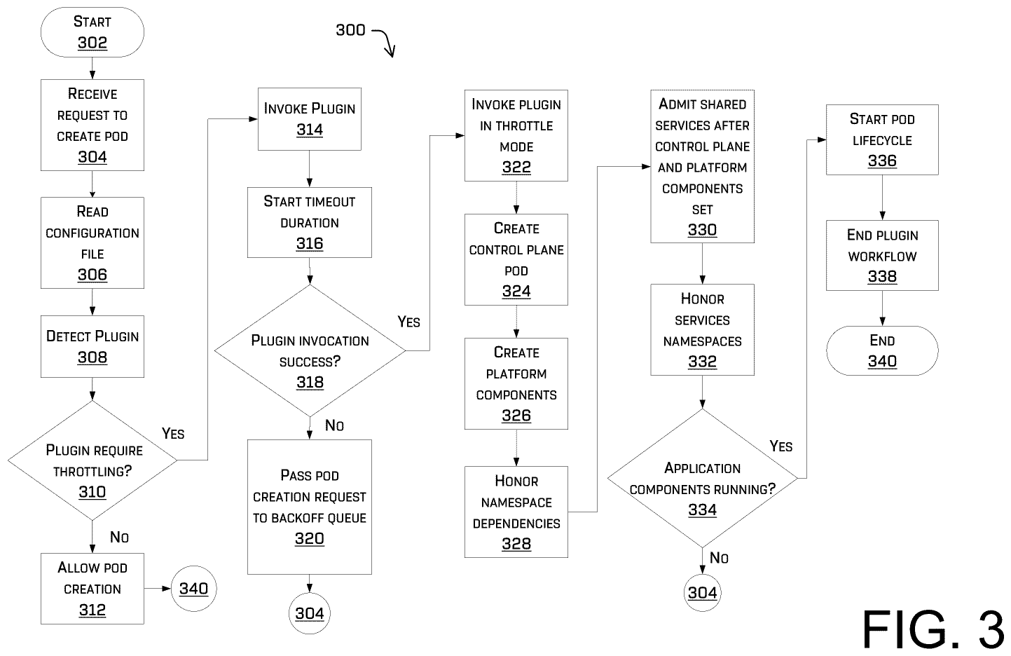

Referring still to FIG. 1, each node 126, 150 includes a Kubelet 146, 164. According to examples, as understood by those skilled in the art, Kubelets 146, 164 serve as node agents that run on each node 126, 150. Kubelets run on each node of the cluster 100 and are responsible for managing the lifecycles of containers housed in pods in the nodes 126, 150. According to examples, Kubelets may receive information from the API server 112 about containers that should run in respective pods in respective nodes. Kubelets ensure that containers are running by monitoring their status and by responding appropriately to issues that arise. As described herein, Kubelets interact with containers via a container runtime in the nodes which is responsible for starting and stopping containers, at the direction of controllers 118, 120, 122 via the API server 112. According to examples of the present disclosure, the Kubelets 146, 164 are responsible for pod and/or associated container creation according to the pluggable mechanism described below with reference to FIG. 3.

Referring still to FIG. 1, the Kube-proxies 148, 166 are network proxies that run on each node 126, 150. The Kube-proxies are responsible for maintaining network connectivity between services by translating services definitions into network rules that may be acted upon by the cluster 100.

FIG. 2 illustrates a system architecture diagram of an environment for pod and/or container creation via invocation of one or more plugins. According to examples, and as will be described in further detail below with reference to FIG. 3, a general-purpose or special-purpose pluggable mechanism may be used to manage pod and/or associated container creation for preventing resource starvation where insufficient CPU and/or memory is available for desired pod and/or associated container operations and/or service throttling where utilization of service components, for example, pod and/or associated container operation is delayed or prevented owing to insufficient resources. Referring to FIG. 2, in response to a communication from the API server 112 to a Kubelet 146, the Kubelet 146 may utilize a container management policy interface (CMPI) 204 to configure a container 134 in an associated pod 128. To configure a pod 128 and/or associated container 134. According to examples, the Kubelet 146 may call one or more available plugins 206 via the CMPI 204 for use in implementing one or more configurations of a pod or container in which the containerized application(s) reside. As understood by those skilled in the art, plugins 206 may include binary executable software applications or components that add to or alter functionality of existing software applications. According to examples of the present disclosure, plugins 206 may be used to manage pod and/or associated container creation in a manner that prevents resources starvation or services throttling.

Referring still to FIG. 2, in order to determine which of one or more plugins 206 are needed for a given operation, the Kubelet 146 may read a configuration file 202 maintained on each node 126, 150. In response to determining a required plugin 206 from the configuration file 202, the Kubelet 146 retrieves the desired plugin 206 via the CMPI 204. The Kubelet 146 may then execute the retrieved plugin 206 as part of the process to create, update or delete the pod 128 including the associated container 134 as described below with reference to FIG. 3.

According to examples, these self-contained executable plugins 206 available via the configuration file 202 may be utilized for preventing resource starvation and thundering herd events. Such plugins may be invoked by a Kubelet based on the lifecycle events of the services running on a node at the direction of a controller. According to one example, pluggable mechanisms described herein control the entry point of a service to prevent thundering herd issues instead of attempting to prevent them later in the service lifecycle. At a high level, when a pod is requested to be created, a Kubelet detects the presence of a general-purpose or special-purpose plugin associated with the requested pod and/or an associated container by querying a configuration file. Once the Kubelet detects the plugin, it will invoke the plugin and wait for the plugin to give a go ahead with regards to the creation of the pod for the service in question. The duration around the time that the plugin is allowed to take for making a decision to create the requested pod is time-boxed. If the plugin fails to decide in the allowed time, the Kubelet passes the request to create the pod into a back off queue rather than allowing the pod to be created that may cause a thundering herd event.

If the Kubelet determines that the pod may be created, but in a throttled mode, the pod is created according to a methodical or hierarchical schedule. For example, if the requested pod is for the control plane, creation proceeds. If the requested pod is for platform components, creation proceeds after the control plane is up and running. If intra or inter namespace dependencies are present, those dependencies are honored during pod creation. If the requested pod will have shared resources with another pod, the pod is created to provide for the shared resources after the control plane and platform components are up and running and in view of any intra service dependency ordering. If the requested pod is application related, the Kubelet ensures all application components are running. Finally, any intra or inter namespace dependencies are honored.

As should be appreciated, a general-purpose plugin may be provided for a number of needs that may be associated with many containerized applications across an array of containers, pods or nodes. For example, a general-purpose plugin may alter all applications in a cluster to cause data storage associated with all applications to pass to a database according to a new data transport system. On the other hand, a special-purpose plugin may cause a given application, container or pod behavior required by a developer or user of the application. For example, a special-purpose plugin may cause pod and/or associated container creation, as described herein, to be performed according to a methodical approach, as described herein. According to one example, the present disclosure includes a special-purpose plugin to assist in pod and/or associated container creation to avoid the thundering herd problems.

According to examples, the CMPI 204 is a special-purpose plugin or interface, utilized by a Kubelet 146, 164 to affect and manage a pod's lifecycle hooks such as create, update, delete. According to one example, these hooks are outside of the context of the one run inside the context of the container itself. The CMPI 204 may be in the form of a Maglev Node Interface (MNI). This special-purpose plugin or interface may be hooked into the pod's lifecycle at the individual node of a controller. This provides an external mechanism to customize pod lifecycle management to prevent issues around thundering herd issues. The core idea of such a method is to provide an external mechanism that consumers of this method can customize to match their need and hook it into the Lifecycle management to prevent issues around thundering herd problems. The CMPI 204 may be a self-contained executable plugged into the controller which is then invoked by the Kubelet based on the lifecycle events of the services running on a given node of an associated controller. Use of the CMPI 204 provides for control of the entry point of a service to prevent the thundering herd issues at the source instead of attempting to prevent such issues in the lifecycle.

FIG. 3 illustrates a flow diagram of an example method for managing resource capacity and service throttling to prevent system caching overloading resulting in thundering herd problems. The method 300 begins at START operation 302 and proceeds to operation 304 where a request to create a pod 128 and an associated container 134 on a node 126 is received. As should be appreciated, description of creation of a pod 128 and associated container 134 on the node 126 is for purposes of illustration only, and creation of a given pod and/or a given pod and/or associated container may be requested for any of a number of different nodes 126, 150. As illustrated and described above with reference to FIG. 1, the request for creating the pod and/or associated container may be for purposes of horizontal scaling to add additional containerized application functionality to the cluster 100.

The request for creating the pod and/or associated container may pass from a controller 118, 120, 122 through the controller manager 116 to the API server 112. The API server 112 may then pass an instruction to create the requested pod and/or associated container to a Kubelet 146, 164 of the node 126, 150 or other node at which the requested pod and/or associated container are to be created. As should be appreciated, if the requested pod and/or associated container is for purposes of horizontal scaling of the cluster 100, the instruction or request to create the pod and/or associated container may come from the replication controller 118. Alternatively, the request to create the desired pod and/or associated container may originate from the job controller 120 where the requested pod and/or associated container are needed by job controller 120 for completing a desired or needed job or task. The request for creation of a desired pod and/or associated container may come from one or more other controllers 122, for example, a specialized or customized controller utilized for creating and managing one or more pods and associated containers according to a specialized or customized need from a developer 168, user 170, or cluster component.

At operation 306, the Kubelet 146, 164 resident on the node 126, 150 at which the requested pod and/or associated container will be created reads the configuration file 202, as described above with reference to FIG. 2. At operation 308, in response to the Kubelet reading the configuration file 202, the Kubelet 146, 164 detects the presence of one or more plugins that may be required in association with creation of the requested pod and/or associated container.

At operation 310, a determination is made by the Kubelet 146, 164 as to whether the detected plugins 206 associated with pod creation request include a plugin that requires pod startup throttling. Prior to determining from a detected plugin that the pod is to be created in a throttled mode, the configuration file 202 is read to determine a configuration for the plugin. That is, a determination is made as to whether a detected plugin as read from the configuration file 202 requires that the requested pod be created in a throttling mode to prevent pod creation in a manner that leads to resources starvation or services throttling owing to insufficient resources, for example, CPU and memory, needed for creating the requested pod without causing resource starvation or services throttling. If the detected plugin(s) 206 do not require pod startup throttling, the method proceeds to operation 312 and the requested pod may be created, and associated services may be allowed to start up according to containerized applications created or replicated according to the one or more plugins 206 detected in the configuration file 202. The method 300 may then move to END operation 340.

Referring back to operation 310, if the detected plugin(s) 206 read from the configuration file 202 do indicate that pod startup will require throttling, the method proceeds to operation 314. At operation 314, the Kubelet 146, 164 invokes the detected and retrieved plugin(s) 206 in a configuration mode. That is, the Kubelet 146, 164 determines whether the invoked plugin(s) requires an override to customize pod creation via a standard output (STDOUT) return from the Kubelet's query of the configuration file 202. As should be appreciated, the output return from the Kubelet's query of the configuration file 202 may require the Kubelet 146, 164 to add or delete or check a given pod. According to examples of the present disclosure, the retrieve plugin may require pod creation according to the method described herein to avoid thundering herd issues.

At operation 316, a timeout duration counter is started during which successful (or not) invocation and execution of the invoked plugin is determined. At operation 318, the Kubelet 146, 164 validates plugin output via the standard output (STDOUT) to determine whether invocation of the retrieved plugin is successful during the timeout duration. If the Kubelet 146, 164 does not receive a successful and execution of the retrieved plugin during a prescribed timeout duration at operation 318, the method proceeds to operation 320 and the Kubelet places the pod and/or associated container creation process into a backoff queue so that continued processing of the pod and/or associated container creation does not starve cluster resources of CPU and/or memory needed by other cluster processes or does not require a throttling of one or more other services while the pod and/or associated container are created. If the pod creation pod and/or associated container creation process is placed into the backoff queue, the method returns back to operation 304 and awaits processing at a subsequent time when cluster resources are available to process the pod and/or associated container creation request without causing resource starvation or services throttling.

Referring back to operation 318, if the Kubelet 146, 164 validates the retrieved plugin 206 as a success output during the timeout duration, the method proceeds to operation 322. At operation 322, the Kubelet 146, 164 invokes the plugin in a throttle mode with timeout duration detected by the configuration mode output validated at operation 318. That is, even if the Kubelet determines pod and/or associated container creation may continue in a throttling mode, a timeout duration for processing may still be utilized to prevent pod and/or associated container creation from slowing or overloading cluster operations and potentially causing thundering herd problems.

If the Kubelet invokes the retrieved plugin(s) 206 in throttle mode with a timeout duration detected by the configuration mode output, the Kubelet 146, 164 follows the above-described orderly process for executing the requested pod and/or associated container creation. For example, if the requested pod and/or associated container are for control plane operations, then the method proceeds to operation 324, and the requested pod and/or associated container are created and run immediately without further delay. At operation 326, if the requested pod and/or associated container are for platform components, the Kubelet 146, 164 waits for the control plane or node 110 to be set up and running, and then the requested pod and/or associated container are created and run.

At operation 328, the Kubelet 146, 164 determines whether there are inter or intra namespace dependencies between containers or between the requested pod and other pods. If there are such inter or intra namespace dependencies, those dependencies are honored during creation of the requested pod and/or associated container and subsequent startup. At operation 330, if the requested pod is for shared resources between related pods or between related containers of a pod, the Kubelet 146, 164 waits for control plane and platform components to be up and running and then admits such dependencies. At operation 332, any intra or inter services namespace dependencies associated with the requested pod and/or associated container are honored by the Kubelet 146, 164.

At operation 334, a determination is made as to whether the requested pod is related to a particular containerized application. If so, the Kubelet 146, 164 ensures that all application components required for the requested containerized application are running. If the components of the containerized application associated with the requested pod are not running, the requested pod can be deleted, and the method route proceeds back to operation 304 where the requested pod creation associated with a particular containerized application is placed in a back off queue from which the pod creation will be attempted again when cluster resources are available that will not result in cluster resource starvation or services throttling, as described herein.

At operation 336, the pod lifecycle operations for the requested and created pod and/or associated container are started. At operation 338, the plugin workflow associated with the requested pod and/or associated container creation is completed. The method 300 ends at END operation 340.

According to examples, the techniques and mechanisms described above may define dependencies between the pod and/or associated container categories set out above in a programmatic manner in both static and dynamic configurations. For example, any service can indicate dependency on one or more service categories above itself. Any service can indicate dependency on a subset of services above it or parallel to it. When defining such dependencies, cycling dependency chains should be avoided that can put cluster, pod, or application processing into a deadlock state. This can be detected using a static analysis tool around the configuration in the pipelines. According to examples, control plane pods may be grouped into two categories. static and non-static pods. Control plane static pods and non-static pods are not affected as static pods are created and allowed to run, as set out above, given the need for the control plane to operate for the entire cluster. enforcement done since they are the backbone of the cluster. Platform components pods are started right after the control plane pods creation before any other components are started. These services can define intra category dependency to sequence themselves if required. Shared services such as databases and message queues, and the like may be brought up before any other services are started to avoid unwanted issues that the services might run into at the startup as a result of conflict with other services. Applications can define dependencies across namespaces if required in terms of operating according to application service bootstrap workflow.

According to examples, the techniques and mechanisms described above may follow one or more conventions to assist in the efficacy of pod and/or associated container creation. For example, the above-described method 300 may be extendable and configurable such that it requires minimal to no changes to the services and applications running according to a given controller. The method may exist out of tree to a particular containerized application and not mandate any modification to existing applications or services. The method 300 may be configurable to allow it to be switched on and off if required the method from itself causing thundering herd problems if detected. The method 300 may be implemented agnostic of other services or applications running according to a requesting controller to ensure that the mechanism is reusable and not purpose built to solve a single problem. The method 300 may be implemented as a stateless operation to avoid concerns around state management and add additional unwanted processing overhead.

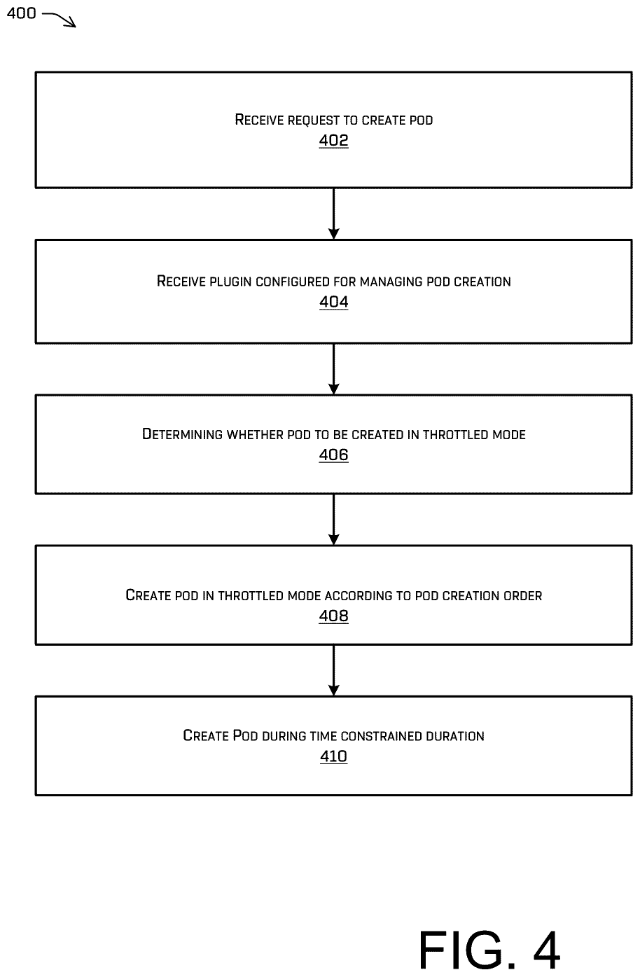

FIG. 4 illustrates a flow diagram of an example method 400 for managing resource capacity and service throttling to prevent system caching overloading resulting in thundering herd problems. At step 402, a request to create a pod 128 and an associated container 134 on a node 126 is received. As illustrated and described above with reference to FIG. 1, the request for creating the pod and/or associated container may be for purposes of horizontal scaling to add additional containerized application functionality to the cluster 100. The request for creating the pod and/or associated container may pass from a controller 118, 120, 122 through the controller manager 116 to the API server 112. The API server 112 may then pass an instruction to create the requested pod and/or associated container to a Kubelet 146, 164 of the node 126, 150 or other node at which the requested pod and/or associated container are to be created.

At step 404, a plugin configured for managing creation of the pod according to a pod creation order is received. According to examples, the Kubelet 146, 164 resident on the node 126, 150 at which the requested pod and/or associated container will be created reads the configuration file 202, as described above with reference to FIG. 2. In response to the Kubelet reading the configuration file 202, the Kubelet 146, 164 detects the presence of one or more plugins that may be required in association with creation of the requested pod and/or associated container.

At step 406, a determination is made from the received plugin(s) that the pod is to be created in a throttled mode. At step 408, the pod is created in the throttled mode according to the according to the pod creation order. At step 410, when the pod is created, it is created during a time-constrained duration. According to one example, if the pod is not created during the time-constrained duration, the request to create the pod is placed into a backoff queue and is processed later when system resources are available.

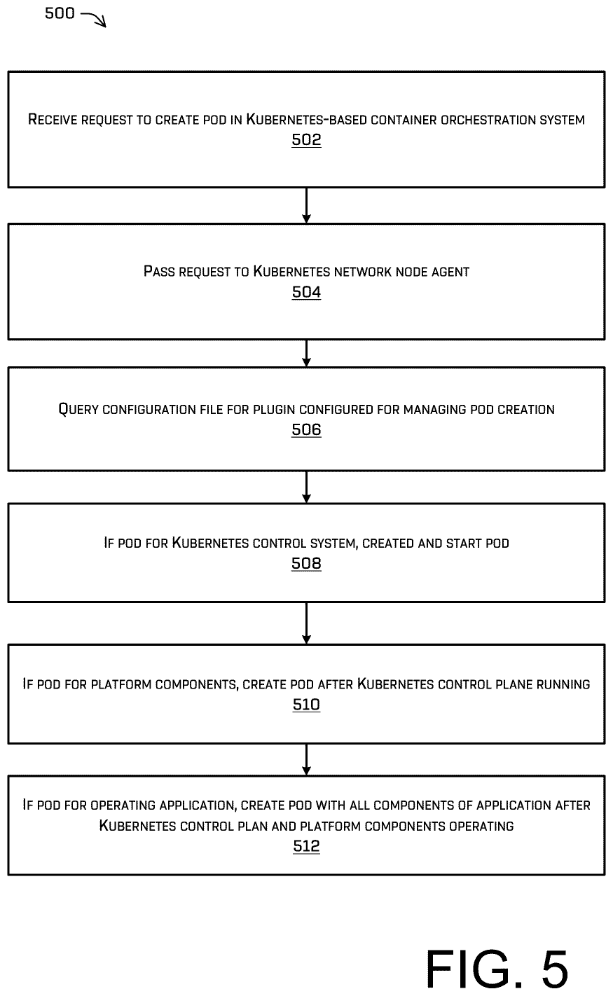

FIG. 5 illustrates a flow diagram of an example method 500 for managing resource capacity and service throttling to prevent system caching overloading resulting in thundering herd problems. At step 502, a request is received to create a pod in a Kubernetes-based container orchestration system. As illustrated and described above with reference to FIG. 1, the request for creating the pod and/or associated container may be for purposes of horizontal scaling to add additional containerized application functionality to the cluster 100. The request for creating the pod and/or associated container may pass from a controller 118, 120, 122 through the controller manager 116 to the API server 112. The API server 112 may then pass an instruction to create the requested pod and/or associated container to a Kubelet 146, 164 of the node 126, 150 or other node at which the requested pod and/or associated container are to be created.

At step 504, the request is passed to a Kubernetes network node agent (Kubelet) from a Kubernetes controller via an application programming interface. At step 506, the network node agent, queries a configuration file for a plugin configured for managing creation of the pod according to a pod creation order.

At step 508, if the pod is requested for a control plane of the Kubernetes-based container orchestration system, the pod is created and the pod is started. At step 510, if the pod is requested for platform components, the pod is created after the control plane is running and continuing operation the pod. At step 512, if the pod is for operating an application, the pod is created with all components of the application after the control plane and the platform components are operating.

FIG. 6 is a computer architecture diagram showing an illustrative computer hardware architecture for implementing a computing system/device that can be utilized to implement aspects of the various technologies presented herein. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a client device and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to start up the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 624. The chipset 606 can include functionality for providing network connectivity through a network interface controller (NIC) 612, such as a gigabit Ethernet adapter. The NIC 612 is capable of connecting the computer 600 to other computing devices over the network 624. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program components, data structures, or other data. It should be appreciated by those skilled in the art that computer-readable storage media is any available media that provides for the non-transitory storage of data and that can be accessed by the computer 600. In some examples, the operations performed by a client device and or any components included therein, may be supported by one or more devices similar to computer 600. Stated otherwise, some or all of the operations performed by a client device and or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

The computer 600 may include one or more hardware processors configured to execute one or more stored instructions. The processor(s) may comprise one or more cores. Further, the computer 600 may include one or more network interfaces configured to provide communications between the computer 600 and other devices, such as the communications described herein as being performed by the cluster 100. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for preventing resource starvation and service throttling during container orchestration system operations. Such programs or processes may include pluggable mechanisms that are applied to pod and/or associated container creation and operation at the direction of a cluster controller to prevent resource overloading and service throttling during thundering herd problems encountered by components of a Kubernetes cluster. A special-purpose plugin may be provided that causes creation of a pod and/or associated container according to a prescribed order to prevent caching overload and resulting thundering herd problems during pod and/or associated container creation and startup.

While the invention is described with respect to the specific examples, it is to be understood that the scope of the invention is not limited to these specific examples. Since other modifications and changes varied to fit operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving a request to create a pod in a container orchestration system having a control plane node and one or more worker nodes;
receiving a plugin configured for managing creation of the pod according to a pod creation order;
determining from the plugin that the pod is to be created in a throttled mode; and
creating the pod in the throttled mode according to the pod creation order.

2. The method of claim 1, further comprising:
creating the pod during a time-constrained duration; and
if creating the pod according to the pod creation order fails to complete during the time-constrained duration, ceasing creating the pod.

3. The method of claim 2, wherein if creating the pod if ceased, moving a request to create a pod to a backoff queue.

4. The method of claim 3, wherein after moving the request to create a pod to a backoff queue, when processing resources are available, restarting a creating of the pod.

5. The method of claim 1, wherein if the pod is not to be created in a throttled mode, creating the pod and allowing the pod to start.

6. The method of claim 1, wherein managing creation of the pod according to a pod creation order includes if the pod is requested for the control plane node, proceeding with creating the pod.

7. The method of claim 6, wherein managing creation of the pod according to a pod creation order includes if the pod is requested for platform components, creating the pod after the control plane node is running.

8. The method of claim 1, wherein if namespace dependencies between the pod and another pod are detected, creating the pod while maintaining the namespace dependencies.

9. The method of claim 1, wherein if the pod is associated with one or more shared resources of the pod with another pod, creating the pod with the one or more shared resources after the control plane node and platform components are running.

10. The method of claim 1, wherein if the pod is for operating an application, creating the pod with all components of the application.

11. The method of claim 1, wherein receiving a request to create a pod in a container orchestration system having a control node and one or more worker nodes includes receiving the request to create the pod from a control node controller via an application programming interface.

12. The method of claim 1, wherein prior to determining from the plugin that the pod is to be created in a throttled mode, further comprising reading a configuration file and determining a configuration for the plugin.

13. The method of claim 1, wherein receiving a plugin configured for managing a creation of the pod according to a pod creation order includes receiving the plugin via a container network interface.

14. The method of claim 1, prior to determining from the plugin that the pod is to be created in a throttled mode invoking the plugin configured for managing a creation of the pod.

15. A method comprising:
receiving a request to create a pod in a Kubernetes-based container orchestration system;
passing the request to a Kubernetes network node agent from a Kubernetes controller via an application programming interface;
at the Kubernetes network node agent, querying a configuration file for a plugin configured for managing creation of the pod according to a pod creation order;
if the pod is requested for a control plane node of the Kubernetes-based container orchestration system, creating and starting operation of the pod;
if the pod is requested for platform components, creating the pod after the control plane node is running and continuing operation the pod; and
if the pod is for operating an application, creating the pod with all components of the application after the control plane node and the platform components are operating.

16. The method of claim 15, wherein if the pod is associated with one or more shared resources of the pod with another pod, creating the pod with the one or more shared resources after the control plane node and platform components are running.

17. The method of claim 15, further comprising:
creating the pod during a time-constrained duration;
if creating the pod according to the pod creation order fails to complete during the time-constrained duration, ceasing creating the pod;
moving the request to create the pod to a backoff queue; and
when processing resources are available, restarting creating the pod according to the pod creation order.

18. A system comprising:
one or more processors; and
one or more non-transitory computer-readable media storing computer-executable instructions that, when executed by the one or more processors, cause the one or more processors to perform operations comprising:
receiving a request to create a pod in a container orchestration system having a control plane node and one or more worker nodes;
receiving a plugin configured for managing creation of the pod according to a pod creation order;
determining from the plugin that the pod is to be created in a throttled mode; and
creating the pod in the throttled mode according to the pod creation order.

19. The system of claim 18, further comprising:
creating the pod during a time-constrained duration;
if creating the pod according to the pod creation order fails to complete during a time-constrained duration, ceasing creating the pod; and
if creating the pod if ceased, moving the request to create the pod to a backoff queue; and
when processing resources are available, restarting creating the pod according to the pod creation order.

20. The system of claim 18, wherein creating the pod in the throttled mode according to the pod creation order, includes:
if the pod is requested for a container orchestration system control plane, creating and starting operation of the pod;
if the pod is requested for platform components, creating the pod after the container orchestration system control plane is running and continuing operation the pod; and
if the pod is for operating an application, creating a pod container with all components of the application after the control plane node and the platform components are operating.
